(19) United States
(12) Patent Application Publication
(10) Pub. No.: US 2019/0056618 A1
(43) Pub. Date: Feb. 21, 2019

(54) DISPLAY PANEL AND MANUFACTURING METHOD THEREOF

(71) Applicants: BOE TECHNOLOGY GROUP CO., LTD., Beijing (CN); CHENGDU BOE OPTOELECTRONICS TECHNOLOGY CO., LTD., Chengdu (CN)

(72) Inventor: Yuanjie XU, Beijing (CN)

(21) Appl. No.: 15/958,684

(22) Filed: Apr. 20, 2018

(30) Foreign Application Priority Data
Aug. 16, 2017 (CN) 201710701617.X

(51) Int. Cl. G02F 1/1335

(52) U.S. Cl. CPC G02F 1/133514; G02F 1/133512

(57) ABSTRACT

Embodiments of the present invention provides a display panel and a method for manufacturing the display panel. The display panel includes an array substrate and an opposed substrate arranged opposite to the array substrate, wherein the opposed substrate includes a plurality of pixel units and negative refractive index material layers, each of the plurality of pixel units includes a color filter layer, and each of the negative refractive index material layers is disposed between the color filter layers of two adjacent pixel units of the plurality of pixel units.

### TECHNICAL FIELD

Embodiments of the present invention relate to a display panel and a manufacturing method thereof.

### BACKGROUND

The traditional display panel generally comprises a plurality of pixel units. These pixel units tend to emit light of different colors, e.g., red, green and blue. In the display panel, adjacent pixel units are generally spaced from each other through a black matrix (BM), but the blocking function of the BM tends to be limited, so the crosstalk still occurs between light from adjacent pixel units. For example, light from a red pixel unit will be irradiated to a green pixel unit or a blue pixel unit adjacent to the red pixel unit, resulting in the phenomenon of color offset. In addition, light from partial pixel units will also be irradiated to the BM and absorbed or blocked by the BM, resulting in low light transmittance of the display panel and low light utilization rate.

### SUMMARY

At least one embodiment of the present disclosure provides a display panel and a manufacturing method thereof, which can avoid the crosstalk of light and color offset, reduce the light absorption of the black matrix, and hence improving the light utilization rate.

At least one embodiment of the present disclosure provides a display panel, which comprises: an array substrate and an opposed substrate arranged opposite to the array substrate, wherein the opposed substrate includes a plurality of pixel units and negative refractive index material layers; each of the plurality of pixel units includes a color filter layer; and each of the negative refractive index material layers is disposed between the color filter layers of two adjacent pixel units of the plurality of pixel units.

At least one embodiment of the present disclosure provides a method for manufacturing a display panel, which comprises: providing an array substrate and an opposed substrate and cell-assembling the array substrate and the opposed substrate, wherein a plurality of pixel units are formed in the opposed substrate, each of the plurality of pixel units includes a color filter layer, and a negative refractive index material layer is formed between the color filter layers of two adjacent pixel units.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a schematic diagram of a traditional display panel;

FIGS. 2A and 2B are first schematic diagrams of a display panel provided by an embodiment of the present invention;

FIGS. 3A and 3B are second schematic diagrams of a display panel provided by an embodiment of the present invention;

FIGS. 4A and 4B are respectively schematic diagrams illustrating the light refraction effect of positive refractive index materials and negative refractive index materials;

FIG. 5 is a third schematic diagram of a display panel provided by an embodiment of the present invention;

FIG. 6 is a fourth schematic diagram of a display panel provided by an embodiment of the present invention;

FIGS. 7A and 7B are schematic diagrams illustrating the adjustment of the light shielding width of the negative refractive index material layer in the display panel provided by an embodiment of the present invention;

FIG. 8 is a fifth schematic diagram of a display panel provided by an embodiment of the present invention;

FIGS. 9A-9E are first schematic diagrams of a method for manufacturing a display panel, provided by an embodiment of the present invention;

FIGS. 10A and 10B are second schematic diagrams of a method for manufacturing a display panel, provided by an embodiment of the present invention;

FIGS. 11A and 11B are third schematic diagrams of a method for manufacturing a display panel, provided by an embodiment of the present invention;

FIGS. 12A-12B are schematic diagrams illustrating forming a photonic crystal layer in an embodiment of the present invention; and

FIGS. 13A-13B are schematic diagrams illustrating a process of forming negative refractive index material layer in an embodiment of the present invention.

Reference numerals of the accompanying drawings:

10—array substrate; 20—opposed substrate; 201—CF layer; 202—BM; 203—negative refractive index material layer; 203A—red negative refractive index material layer; 203B—green negative refractive index material layer; 203C—blue negative refractive index material layer; 204—liquid crystal material; 2030—partial negative refractive index material layer; 2031—base material; 2032—large hole; 2033—small hole.

### DETAILED DESCRIPTION

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

Unless otherwise defined, all the technical and scientific terms used herein have the same meanings as commonly understood by one of ordinary skill in the art to which the present disclosure belongs. The terms, such as “first,” “second,” or the like, which are used in the description and the claims of the present disclosure, are not intended to indicate any sequence, amount or importance, but for distinguishing various components. The terms, such as “comprise/comprising,” “include/including,” or the like are intended to specify that the elements or the objects stated before these terms encompass the elements or the objects and equivalents thereof listed after these terms, but not preclude other elements or objects. The terms, such as “connect/connecting/connected,” “couple/coupling/coupled” or the like, are not limited to a physical connection or mechanical connection, but may include an electrical connection/coupling, directly or indirectly. The terms, “on,” “under,” or the like are only used to indicate relative position relationship, and when the position of the object which is described is changed, the relative position relationship may be changed accordingly.

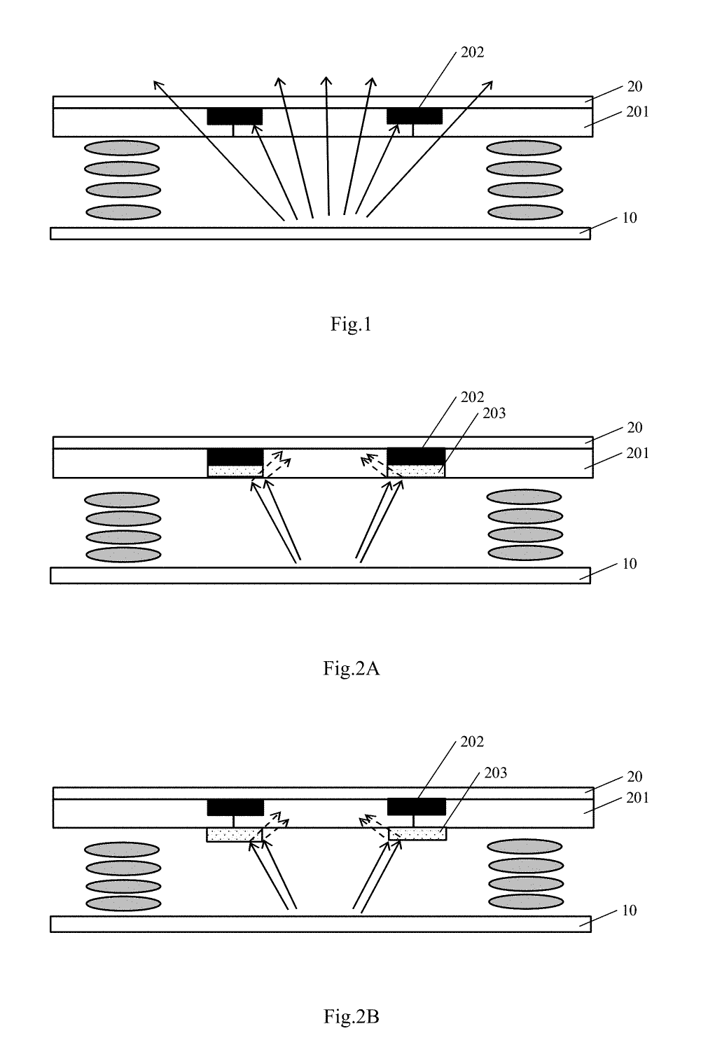

As shown in FIG. 1, a display panel generally comprises a plurality of pixel units. The pixel units include color filter (CF) layers 201 with different colors such as red, green and blue, so that the display panel can emit light of different colors. Adjacent pixel units are usually spaced from each other through a BM 202, but the blocking function of the BM 202 tends to be limited, so the crosstalk still occurs between light from adjacent pixel units. For example, light from a red pixel unit will be irradiated to a green pixel unit or a blue pixel unit adjacent to the red pixel unit, resulting in the phenomenon of color offset. In addition, light from partial pixel units will also be irradiated to the BM 202 and absorbed or blocked by the BM 202, resulting in low light transmittance of the display panel and low light utilization rate.

At least one embodiment of the present invention provides a display panel, which comprises an array substrate and an opposed substrate which is arranged opposite to the array substrate. The opposed substrate includes a plurality of pixel units and a negative refractive index material layer. The pixel unit includes a CF layer. The negative refractive index material layer is disposed between the CF layers of two adjacent pixel units.

At least one embodiment of the present invention provides a method for manufacturing a display panel, which comprises: providing an array substrate and an opposed substrate and arranging the array substrate and the opposed substrate oppositely; and forming a plurality of pixel units in the opposed substrate, forming a CF layer in the pixel unit, and forming a negative refractive index material layer between the CF layers of two adjacent pixel units.

Description will be given below to the display panel and the manufacturing method thereof provided by the present invention with reference to the preferred embodiments.

### A First Embodiment

The present embodiment provides a display panel. As illustrated in FIG. 2A, the display panel comprises: an array substrate 10 and an opposed substrate 20 arranged opposite to the array substrate 10, wherein the opposed substrate 20 includes a plurality of pixel units (three shown in the figure) and negative refractive index material layers 203; the pixel unit includes a CF layer 201; and the negative refractive index material layer 203 is disposed between the CF layers 201 of two adjacent pixel units.

For instance, the display panel is a liquid crystal display (LCD) panel or an organic light-emitting diode (OLED) display panel. For instance, the LCD panel may comprise a backlight so as to provide a light source for display; and the OLED display panel comprises an OLED element. The plurality of pixel units are arranged in an array. The array may include a row direction and a column direction. FIG. 2A and other accompanying drawings are, for instance, schematic sectional views in the row direction or the column direction.

For instance, in the display panel provided by the embodiment, the opposed substrate 20 may further include a BM 202, and the negative refractive index material layer 203, for instance, may be disposed at a position between the CF layers 201 of two adjacent pixel units and corresponding to the BM 202.

For instance, a width of the negative refractive index material layer 203 may be the same with a width of the BM 202. For instance, as shown in FIG. 2A, the negative refractive index material layer 203 may be arranged in the same layer with the CF layer 201 and is disposed at the position between the CF layers 201 of two adjacent pixel units and corresponding to the BM 202. For instance, as shown in FIG. 2B, the negative refractive index material layer 203 may also be disposed on a side of the CF layer 201 facing the array substrate 10 and at the position between the CF layers 201 of two adjacent pixel units and corresponding to the BM 202.

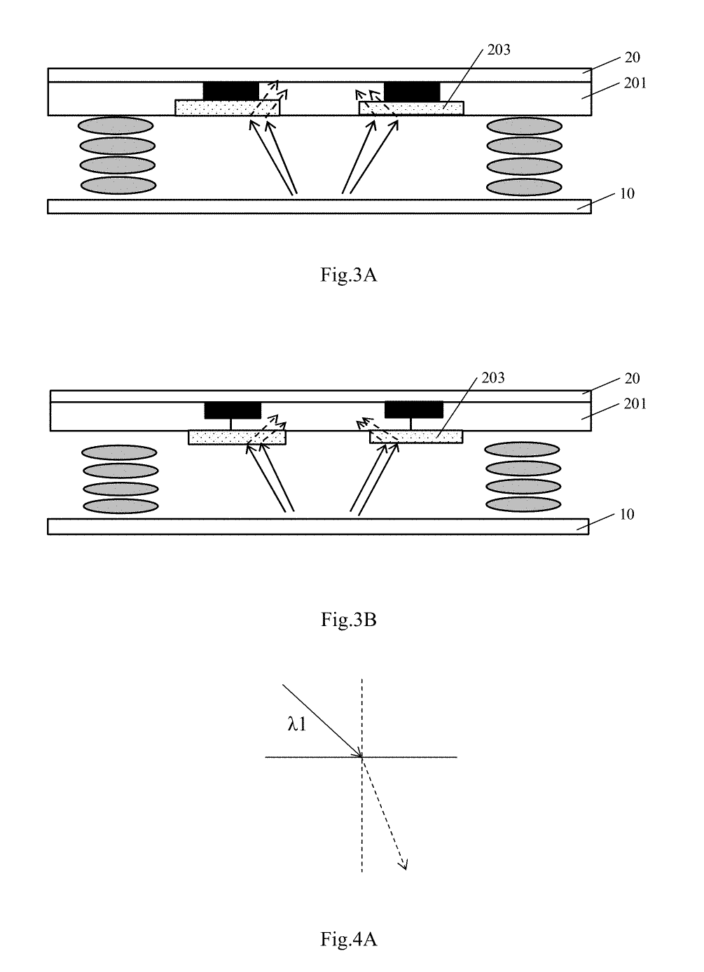

For instance, the width of the negative refractive index material layer 203 may be different from the width of the BM 202. For instance, as shown in FIG. 3A, the negative refractive index material layer 203 may be arranged in the same layer with the CF layer 201 and is disposed at the position between the CF layers 201 of two adjacent pixel units and corresponding to the BM 202. For instance, as shown in FIG. 3B, the negative refractive index material layer 203 may also be disposed on a side of the CF layer 201 facing the array substrate 10 and at the positon between the CF layers 201 of two adjacent pixel units and corresponding to the BM 202.

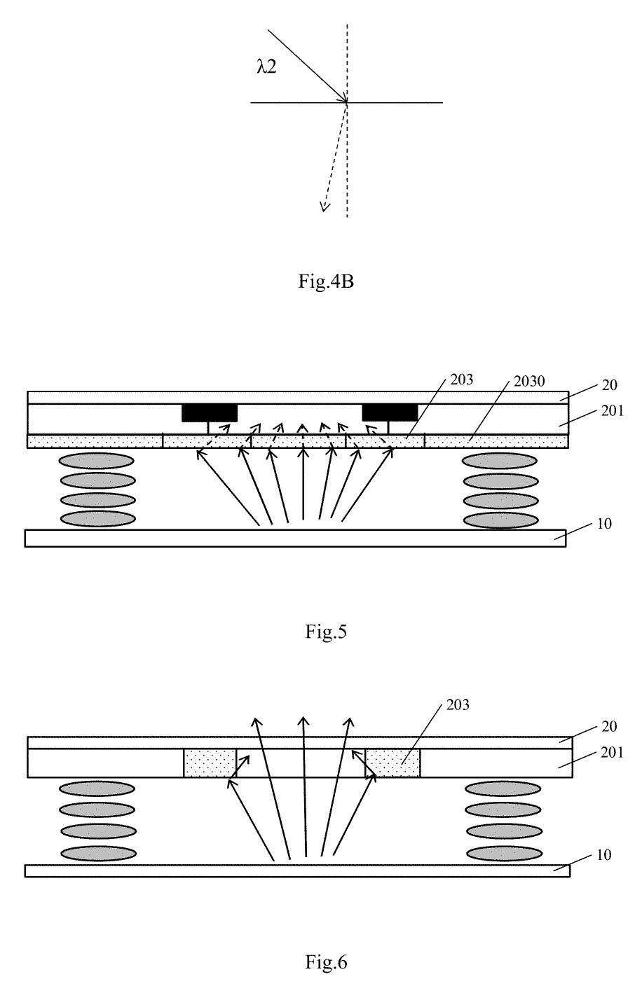

FIGS. 4A and 4B are respectively schematic diagrams illustrating the light refraction effect of a positive refractive index material and a negative refractive index material. As shown in FIG. 4A, when incident light λ1 is incident into the positive refractive index material, emergent light and the incident light are respectively disposed on two sides of a normal of the positive refractive index material. As shown in FIG. 4B, when incident light λ2 is incident into the negative refractive index material, emergent light and the incident light are disposed on the same side of a normal of the negative refractive index material. In the embodiment, the negative refractive index material layer 203 in the display panel has negative refractive index on light, so the negative refractive index material 203 can limit light from the pixel unit in the pixel unit, prevent the light from being incident into adjacent pixel units, and hence avoiding the crosstalk of light between adjacent pixel units and avoiding the phenomenon of color offset. In addition, the negative refractive index material layer 203 can also prevent the light from being incident into the BM 202, which can reduce the light absorption of the BM 202, and hence improving the light utilization rate.

In the embodiment, as shown in FIG. 5, in one example, the negative refractive index material layer 203 not only includes a part corresponding to a region between the CF layers 201 of two adjacent pixel units and on a side of the CF layer 201 facing the array substrate 10 but also includes a part 2030 disposed on a side of the CF layer 201 of each pixel unit facing the array substrate 10. At this point, the negative refractive index material layer 203 may be formed into a continuous layer structure disposed on a side of the CF layer 201 facing the array substrate 10. The continuous layer structure of negative refractive index material layer 203 can refract the light within each pixel unit within a larger range, avoid the crosstalk of light between adjacent pixel units, avoid the phenomenon of color offset, and improve the light utilization rate.

In another example of the embodiment, as shown in FIG. 6, the negative refractive index material layer 203 of the display panel may also be disposed between the CF layers 201 of two adjacent pixel units and isolate the pixel units from each other. At this point, the negative refractive index material layer 203 may replace the BM of the display panel. Compared with the BM, the negative refractive index material layer 203 not only will not absorb light but also has negative refraction effect on light and can limit the light within the pixel unit, and hence can improve the light utilization rate. Meanwhile, the negative refractive index material layer 203 can also avoid the crosstalk of light between adjacent pixel units and avoid the phenomenon of color offset.

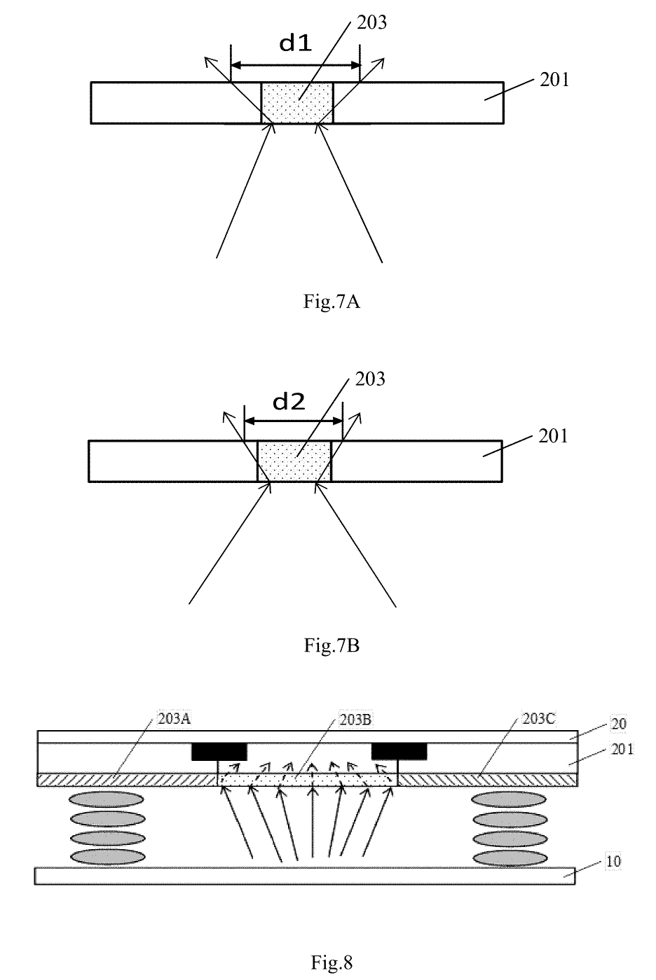

For instance, in the embodiment, the refractive index of the negative refractive index material layer 203 is adjustable. For instance, the negative refractive index material layer 203 may adopt materials sensitive to external factors such as electricity or temperature. Thus, when the material is under the action of electricity or temperature, the refractive index of the material may be changed, so the refractive index of the negative refractive index material layer 203 may be adjusted by applying electrical signals to or changing the temperature of the negative refractive index material layer 203. For instance, when the refractive index of the negative refractive index material layer 203 in the display panel as shown in FIG. 6 is changed, the light shielding width of the negative refractive index material layer 203 will also be changed. For instance, as shown in FIGS. 7A and 7B, when the negative refraction property of the negative refractive index material layer 203 is strong, namely the absolute value of the negative refractive index is large, the light shielding width d1 of the negative refractive index material layer is large, namely the width generated by the negative refractive index material layer, equivalent to the width of the BM, is large. When the negative refraction property of the negative refractive index material layer 203 is weak, namely the absolute value of the negative refractive index is small, the light shielding width d2 of the negative refractive index is small, namely the width generated by the negative refractive index, equivalent to the width of the BM, is small. Therefore, the refractive index of the negative refractive index material layer 203 may be adjusted according to actual demands, so as to change the light shielding range generated by the negative refractive index material layer 203, thus achieving the effect of adjusting the aperture ratio of the pixel unit.

For instance, in the embodiment, the negative refractive index material layer 203 may include a photonic crystal layer with negative refractive index. The photonic crystal layer may be a photonic crystal structure formed by periodically filling functional material into base material. For instance, the photonic crystal layer may be a photonic crystal layer with adjustable negative refractive index formed by periodically filling functional materials such as dielectric materials and metallic materials into a base such as polymer or glass. For instance, in one example of the embodiment, the photonic crystal layer is a temperature-sensitive photonic crystal layer with adjustable negative refractive index formed by periodically filling dielectric ceramic materials and metallic materials into a polytetrafluoroethylene base. The photonic crystal layer has different negative refraction properties at different temperatures. Therefore, the negative refractive index of the photonic crystal layer may be adjusted by adjusting the temperature of the photonic crystal layer.

For instance, in the embodiment, the negative refractive index material layer 203 may have negative refractive index on visible light, so the negative refractive index material layer 203 can have negative refraction effect on all the visible light in the backlight. Moreover, for instance, parts of the negative refractive index material layers 203 respectively corresponding to the pixel unit may respectively have negative refractive index on red, green or blue light. As shown in FIG. 8, red negative refractive index material layer 203A, green negative refractive index material layer 203B and blue negative refractive index material layer 203C are respectively disposed to correspond to the pixel units of with the corresponding colors. Therefore, in the pixel unit, the negative refractive index material layer 203 only has negative refraction effect on light with specific color corresponding to the pixel unit, so the emission intensity of the light with specific color emitted by the pixel unit can be improved. When the negative refractive index material layers 203 have different negative refraction effects on red, green or blue light, the negative refractive index material layers 203 with different widths may be arranged in correspondence to the red, green or blue pixel unit. Therefore, the light-emitting range of the pixel units with different colors can be adjusted by adjusting the width of the negative refractive index material layers 203 corresponding to the pixel units with different colors, namely adjusting the aperture ratio of the pixel units with different colors.

For instance, in the embodiment, the negative refractive index material layer 203 may be a metal mesh grid structure with a square-hole array. The grid structure may, for instance, be a metal mesh grid structure formed by etching the square-hole array in a silver-magnesium fluoride-silver sandwich structure. The grid structure, for instance, may have negative refractive index on light with the wavelength of about 780 nm. For instance, the negative refractive index material layer 203 may be a structure formed by taking a dielectric as a base and radially distributing metal strips in the dielectric base. The structure, for instance, may have negative refractive index on light with the wavelength of about 632 nm.

It should be noted that in the embodiment, the display panel may be a passive emission type display panel such as an LCD panel and may also be an active emission type display panel such as an OLED display panel. The specific type of the display panel is not limited in the embodiment.

### A Second Embodiment

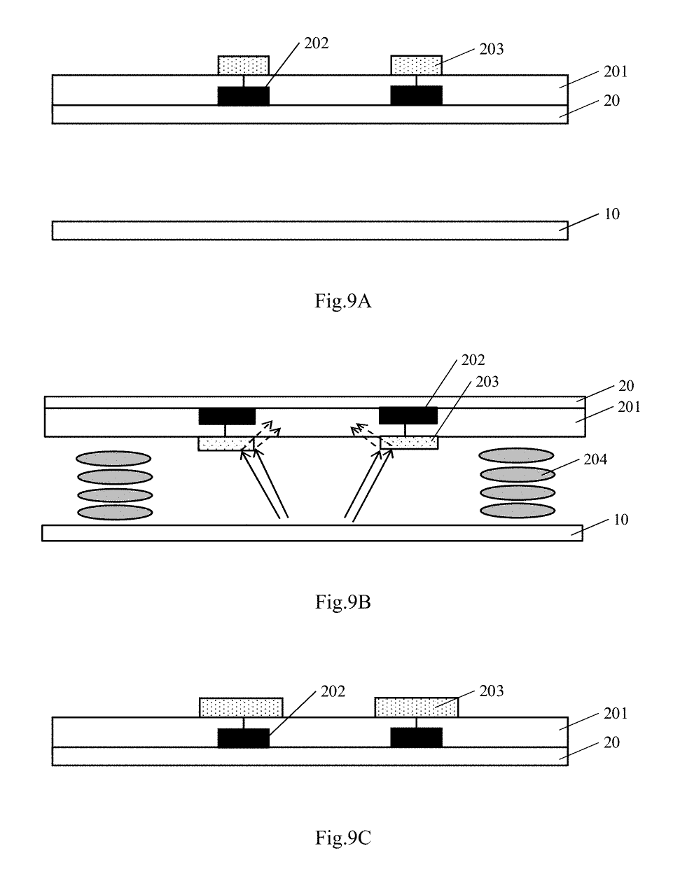

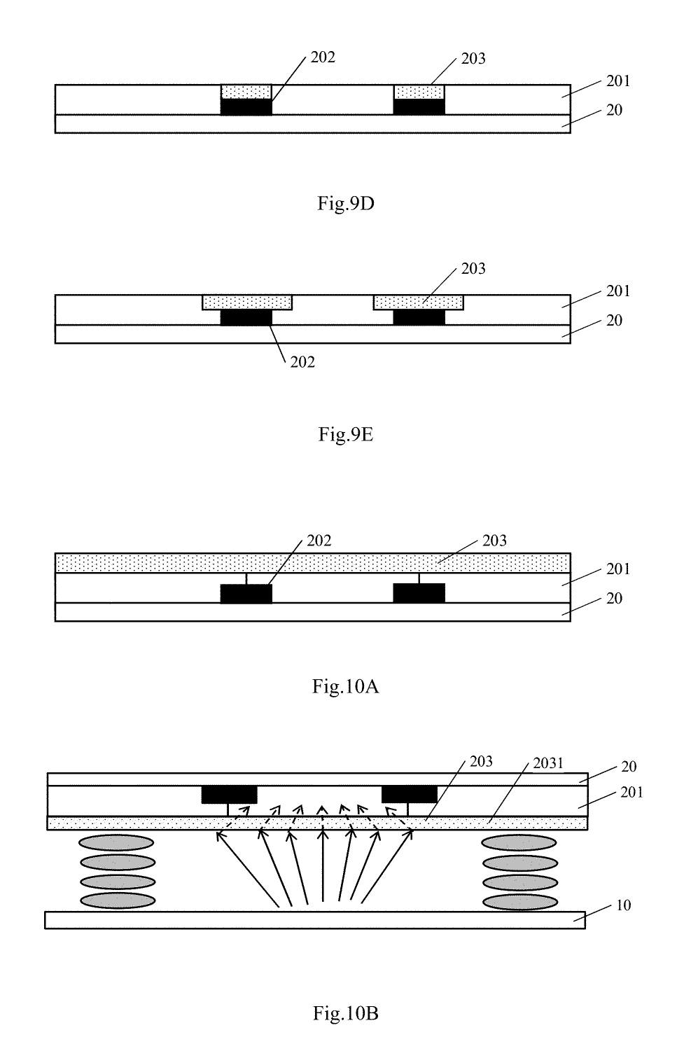

The embodiment provides a method for manufacturing a display panel. As illustrated in FIGS. 9A and 9B, the method comprises: providing an array substrate 10 and an opposed substrate 20 and arranging the array substrate and the opposed substrate oppositely, wherein a plurality of pixel units are formed in the opposed substrate 20; a CF layer 201 is formed in the pixel unit; and a negative refractive index material layer 203 is formed between the CF layers 201 of two adjacent pixel units.

In the embodiment, for instance, a pixel define layer may be formed on the opposed substrate 20 by photolithography, so as to define a plurality of pixel units, and subsequently, the CF layer 201 may be formed in each pixel unit by, for instance, inkjet printing, or the CF layer 201 may be formed by photolithography. The negative refractive index material layer 203, for instance, may be formed by directly forming negative refractive index material at a position between the CF layers 201 of two adjacent pixel units or be a negative refractive index material layer 203 with certain shape and size formed by photolithography.

In the embodiment, when the display panel is an LCD panel, the manufacturing method, for instance, may further comprise the steps of forming a liquid crystal cell by cell-assembling the array substrate 10 and the opposed substrate 20 and injecting liquid crystal material 204 into the liquid crystal cell. No further description will be given in the embodiment.

In the embodiment, the array substrate 10, for instance, may include functional elements such as thin-film transistor (TFT). As for the LCD panel, functional circuits such as a data driving circuit and a gate driving circuit may also be arranged, in which the data driving circuit may be electrically connected with the pixel unit in the array substrate 10 through a data line so as to provide data signal, and the gate driving circuit is electrically connected with the pixel unit in the array substrate 10 through a gate line so as to provide scanning signal.

In the embodiment, BM 202 may also be formed in the opposed substrate 20, and the negative refractive index material layer 203 is formed at a position between the CF layers 201 of two adjacent pixel units and corresponding to the BM 202. In the embodiment, the negative refractive index material layer 203 may be formed in the same layer or different layers with the CF layer 201. A forming width of the negative refractive index material layer 203 may be the same with or different from a width of the BM 202. For instance, FIG. 9A shows the case that the negative refractive index material layer 203 and the CF layer 201 are formed in different layers and the forming width of the negative refractive index material layer is the same with that of the BM 202; FIG. 9C shows the case that the negative refractive index material layer 203 and the CF layer 201 are formed in different layers and the forming width of the negative refractive index material layer is different from that of the BM 202; FIG. 9D shows the case that the negative refractive index material layer 203 and the CF layer 201 are formed in the same layer and the forming width of the negative refractive index material layer is the same with that of the BM 202; and FIG. 9E shows the case that the negative refractive index material layer 203 and the CF layer 201 are formed in the same layer and the forming width of the negative refractive index material layer is different from that of the BM 202.

In the embodiment, the negative refractive index material layer 203 formed in the display panel has negative refractive index on light, so as to limit the light from each of the pixel units in the pixel unit, prevent the light of the pixel unit from being incident into adjacent pixel units, and hence avoid the crosstalk of light between adjacent pixel units, and avoid the phenomenon of color offset. In addition, the negative refractive index material layer 203 can also prevent the light from being incident into the BM 202, so as to improve the light utilization rate.

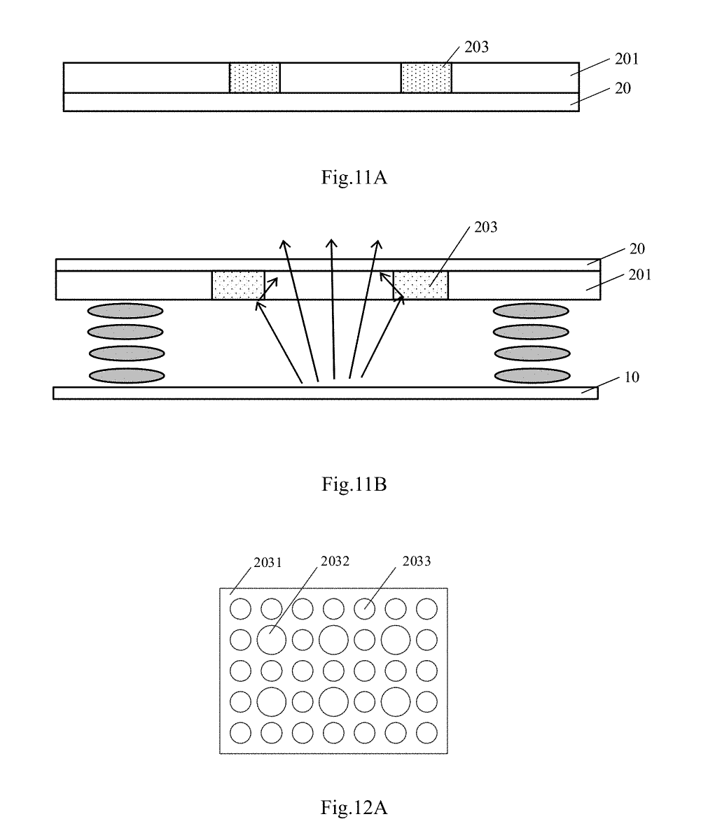

In the embodiment, as shown in FIGS. 10A and 10B, the negative refractive index material layer 203 may also be formed as a continuous layer structure formed on a side of the CF layer of each pixel unit facing the array substrate. The continuous layer structure of the negative refractive index material layer 203 can refract light of each pixel unit within the larger range, avoid the crosstalk of light between adjacent pixel units, avoid the phenomenon of color offset, and improve the light utilization rate.

In the embodiment, as shown in FIGS. 11A and 11B, the negative refractive index material layer 203 may be formed between the CF layers 201 of two adjacent pixel units so as to isolate the pixel units from each other. At this point, the negative refractive index material layer 203 may replace the BM of the display panel. Compared with the BM, the negative refractive index material layer 203 not only can absorb light but also can have negative refraction effect on light, limit the light within the pixel unit, and improve the light utilization rate. In addition, the negative refractive index material layer 203 can also avoid the crosstalk of light between adjacent pixel units and then avoid the phenomenon of color offset.

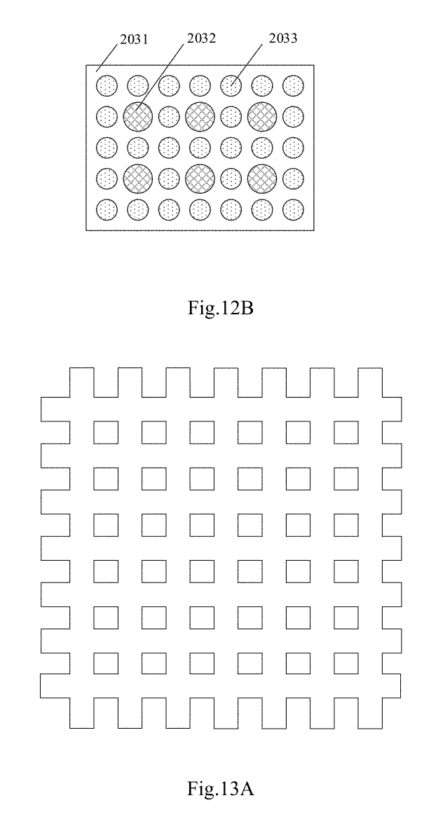

In the embodiment, the negative refractive index material 203, for instance, may be a photonic crystal layer with negative refractive index. In one example of the embodiment, the photonic crystal layer, for instance, may also be a photonic crystal layer with adjustable refractive index. As shown in FIGS. 12A and 12B, forming the photonic crystal layer, for instance, may include: forming periodically arranged holes 2032 and 2033 with different sizes by punching holes in base material 2031, and forming the photonic crystal layer by periodically filling functional material into the periodically arranged holes. For instance, in one example of the embodiment, the base material 2031 may select polytetrafluoroethylene, and the periodically arranged holes as shown in FIG. 12A are formed in the polytetrafluoroethylene. In the example, the holes have two different sizes and are arranged in a form of surrounding the large hole 2032 by the small hole 2033. Wherein, dielectric ceramic material may be, for instance, filled into the large holes 2032 with large size, and metallic material may be filled into the small holes 2033 with small size, thus forming the photonic crystal layer with adjustable refractive index. The photonic crystal layer is sensitive to temperature, namely having different negative refractive indexes on light at different temperatures. Therefore, in the example, the refractive index of the photonic crystal layer may be adjusted by adjusting the temperature applied to the photonic crystal layer according to actual demands. In the embodiment, for instance, the photonic crystal layer may be formed and then disposed at a corresponding position in the opposed substrate 20.

For instance, in the display panel as shown in FIG. 10B, the negative refractive index material layer 203 capable of replacing the BM is formed between the CF layers 201 of two adjacent pixel units. When the negative refractive index material layer 203 adopts the photonic crystal layer with adjustable refractive index, when the refractive index of the photonic crystal layer is changed, the light shielding width of the photonic crystal layer will also be changed. Therefore, the refractive index of the negative refractive index material layer 203 may be adjusted according to actual demands, so as to change the light shielding range of the negative refractive index material layer, and hence the aperture ratio of the pixel units can be adjusted.

In the embodiment, the negative refractive index material layer 203 may select material having negative refractive index on visible light, so the negative refractive index material layer 203 can have negative refraction effect on all the visible light in the backlight. Moreover, for instance, parts of the negative refractive index material layers 203 respectively corresponding to the pixel units may respectively select materials having negative refractive index on red, green or blue light. Therefore, in the pixel unit, the negative refractive index material layer 203 only has negative refraction effect on light with specific color of the pixel unit, so as to improve the emission intensity of the light with specific color emitted by the pixel unit.

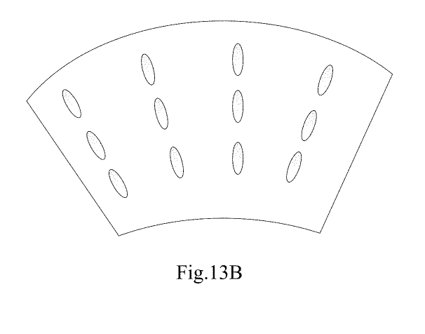

For instance, when the negative refractive index material layer 203 is a metal mesh grid structure with a square-hole array, the grid structure, for instance, may be a metal mesh grid structure as shown in FIG. 13A formed by forming a silver-magnesium fluoride-silver sandwich structure by sequentially forming a silver layer, a magnesium fluoride layer and a silver layer on a glass substrate, and subsequently, etching the square-hole array in the silver-magnesium fluoride-silver sandwich structure. The grid structure, for instance, may have negative refractive index on light with the wavelength of about 780 nm. For instance, when the negative refractive index material layer 203 is a structure that metal strips are filling into an dielectric base, the structure, for instance, may be a structure as shown in FIG. 13B, in which the metal strips are radially distributed in the dielectric base, formed by etching strip holes at corresponding positions of the dielectric base and filling the metal strips into the holes. The structure, for instance, may have negative refractive index on light with the wavelength of about 632 nm.

It should be noted that the negative refractive index material layer 203 may also adopt any other suitable form. No limitation will be given in the embodiment to the negative refractive index materials and the specific structure of the negative refractive index material layer 203.

The following statements should be noted:

(1) The accompanying drawings involve only the structure(s) in connection with the embodiment(s) of the present disclosure, and other structure(s) can be referred to common design(s).

(2) For the purpose of clarity only, in accompanying drawings for illustrating the embodiment(s) of the present disclosure, the thickness and size of a layer or a structure may be enlarged, that is, the accompanying drawings are not drawn according to the actual scale. However, it should understood that, in the case in which a component or element such as a layer, film, region, substrate or the like is referred to be “on” or “under” another component or element, it may be directly on or under the another component or element or a component or element is interposed therebetween.

(3) In case of no conflict, features in one embodiment or in different embodiments can be combined.

What are described above is related to the specific embodiments of the disclosure only and not limitative to the scope of the disclosure. The protection scope of the disclosure shall be based on the protection scope of the claims.

The present application claims priority to the Chinese patent application No. 201710701617.X, filed Aug. 16, 2017, the entire disclosure of which is incorporated herein by reference as part of the present application.

1. A display panel, comprising:
an array substrate and an opposed substrate arranged opposite to the array substrate, wherein the opposed substrate includes a plurality of pixel units and negative refractive index material layers;
each of the plurality of pixel units includes a color filter layer; and
each of the negative refractive index material layers is disposed between the color filter layers of two adjacent pixel units of the plurality of pixel units.

2. The display panel according to claim 1, wherein each of the negative refractive index material layers further includes a portion disposed on a side of the color filter layer of each of the plurality of pixel units facing the array substrate.

3. The display panel according to claim 1, wherein the opposed substrate further includes black matrixes, and each of the negative refractive index material layers is disposed at a position between the color filter layers of two adjacent pixel units and corresponding to the black matrix.

4. The display panel according to claim 1, wherein the negative refractive index material layer is disposed between the color filter layers of two adjacent pixel units of the plurality of pixel units so as to isolate the plurality of pixel units from each other.

5. The display panel according to claim 4, wherein a refractive index of the negative refractive index material layer is adjustable.

6. The display panel according to claim 1, wherein the negative refractive index material layer is a photonic crystal layer with a negative refractive index.

7. The display panel according to claim 6, wherein the photonic crystal layer includes:
a base material, provided with periodically arranged holes; and
a functional material, filled into the periodically arranged holes.

8. The display panel according to claim 1, wherein portions of the negative refractive index material layer respectively corresponding to the pixel units have different widths for red, green or blue pixel units.

9. A method for manufacturing a display panel, comprising:
providing an array substrate and an opposed substrate and cell-assembling the array substrate and the opposed substrate, wherein
a plurality of pixel units are formed in the opposed substrate, each of the plurality of pixel units includes a color filter layer, and a negative refractive index material layer is formed between the color filter layers of two adjacent pixel units.

10. The method for manufacturing the display panel according to claim 9, wherein the negative refractive index material layer is also formed on a side of the color filter layer of each of the plurality of pixel units facing the array substrate.

11. The method for manufacturing the display panel according to claim 9, wherein black matrixes are also formed in the opposed substrate; and the negative refractive index material layer is disposed at a position between the color filter layers of two adjacent pixel units and corresponding to the black matrix.

12. The method for manufacturing the display panel according to claim 9, wherein the negative refractive index material layer is formed between the color filter layers of two adjacent pixel units so as to isolate the plurality of pixel units from each other.

13. The method for manufacturing the display panel according to claim 9, wherein the negative refractive index material layer is a photonic crystal layer with negative refractive index.

14. The method for manufacturing the display panel according to claim 13, wherein the forming the photonic crystal layer includes: forming periodically arranged holes by punching holes on a base material, and periodically filling a functional material into the periodically arranged holes.

15. The method for manufacturing the display panel according to claim 14, wherein the base material is a polytetrafluorethylene substrate; and the functional material is a dielectric ceramic material or the dielectric ceramic material and a metallic material.
